(19) United States
(12) Patent Application Publication
(10) Pub. No.: US 2005/0235033 A1
(43) Pub. Date: Oct. 20, 2005

(54) Method and apparatus for video screening of job applicants and job processing

(76) Inventor: Timothy E. Doherty, Eden Prairie, MN (US)

Correspondence Address: Schwegman, Lundberg, Woessner & Kluth, P.A., P.O. Box 2938, Minneapolis, MN, 55402, US

(21) Appl. No.: 11/091,353

(22) Filed: Mar. 28, 2005

Related U.S. Application Data
(60) Provisional application No. 60/557,104, filed on Mar. 26, 2004.

(51) Int. Cl. G06F 15/16

(52) U.S. Cl. 709/204

(57) ABSTRACT

There is illustrated herein method and apparatus for operating a candidate processing system wherein one or more call center operators are trained to process candidates. One or more call center operators are positioned at respective operator stations. The candidate processing system receiving a plurality of requests to establish a video teleconference session, wherein each request is sent from a remote station used by at least one of the candidates. There is electronically queued two or more of the requests in a call queue. One of the queued video teleconferencing sessions is connected from the candidates to one of the operator stations serviced by the candidate processing system which is staffed by one of the operators, and the candidate is processed through the video teleconference session.

### RELATED APPLICATION

This application claims the benefit of U.S. Provisional Application Ser. No. 60/557,104 filed Mar. 26, 2004, which application is incorporated herein and made a part hereof.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2004, WEMTV, Inc., and Doherty Employment Group, All Rights Reserved.

### TECHNICAL FIELD

Various embodiments described herein relate to processing job applicants, and more particularly to the use of video teleconferencing technologies for processing, screening, testing and hiring job applicants.

### BACKGROUND

Selecting the proper job applicant for a particular job is a time and resource consuming process. Selecting the wrong person for a job can cost an organization large amounts of money in lost training, inefficient performance and general incompatibility with the organization. To reduce the prospect of hiring the wrong candidate, organizations seek to screen only the most likely candidates for a job. In these days of dispersed populations and high transportation costs, the cost of bringing a job candidate to the site of the organization represents a barrier to many organizations

What is needed is a more efficient way of interviewing candidates that decreases the costs associated with interviewing a large enough candidate pool to ensure the most optimal match between the organization and the candidate.

### SUMMARY OF THE INVENTION

According to one example embodiment there is provided method and apparatus for operating a candidate processing process wherein one or more call center operators are trained to process candidates using video teleconferencing or instant messaging. In one example embodiment, two or more requests for processing a candidate are put in a call queue, and operators process candidates from the call queue.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a schematic illustration of a system according to an embodiment of the inventive subject matter described herein.

FIGS. 2A-2B are schematic illustrations of a system according to an embodiment of the inventive subject matter described herein.

FIG. 3 is a schematic illustration of a system according to an embodiment of the inventive subject matter described herein.

FIG. 4A is an illustration of an example user interface according to an embodiment of the inventive subject matter described herein.

FIG. 4B is an example of an implementation of a user interface according to an embodiment of the inventive subject matter described herein.

FIG. 5A-5C are flowcharts of methods according to embodiments of the inventive subject matter described herein.

FIG. 6 is a flowchart of a method according to an embodiment of the inventive subject matter described herein.

FIG. 7 is a flowchart of a method according to an embodiment of the inventive subject matter described herein.

FIG. 8 is a flowchart of a method according to an embodiment of the inventive subject matter described herein.

FIG. 9 is a flowchart of a method according to an embodiment of the inventive subject matter described herein.

FIG. 10 is a flowchart of a method according to an embodiment of the inventive subject matter described herein.

FIG. 11 is a flowchart of a method according to an embodiment of the inventive subject matter described herein.

FIG. 12 is a flowchart of a method according to an embodiment of the inventive subject matter described herein.

FIG. 13A-13H are screenshots of example user interface screens according to an embodiment of the inventive subject matter described herein.

FIG. 14 is an image of a device according to an embodiment of the inventive subject matter described herein.

### DETAILED DESCRIPTION OF THE INVENTION

In the following detailed description of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and logical, mechanical, electrical and other changes may be made without departing from the scope of the inventive subject matter described herein.

Reference in the description is made to a “Candidate Processing System”. The term “Candidate Processing System” as used herein mean a system of computers, software or devices used for the purpose of processing candidates for a job or other placement opportunity. Also, as used herein, the term “Network” means an interconnected group of two or more computers or other devices. A Network may be formed by a connection over a communications link such as, without limitation, the Internet, a private wide area network, a public wide area network, an cable, wire, phone line, local area network or an Ethernet connection. Reference is also made herein to “Instant Messaging”, or “IM”. “Instant Messaging” refers to an interactive text-based conversation between at least two participants, such as a candidate and an operator, over a computer system or network. Typically, an “Instant Messaging” session utilizes a user interface which displays text transmitted during the conversation from both parties in one window area and providing a separate area where the user can enter data that they wish to be transmitted to the other participant. Examples of “Instant Messaging” enabled systems include Yahoo Instant Messenger®, MSN Messenger®, AOL Instant Messenger®, iChat AV® or independently created IM technology.

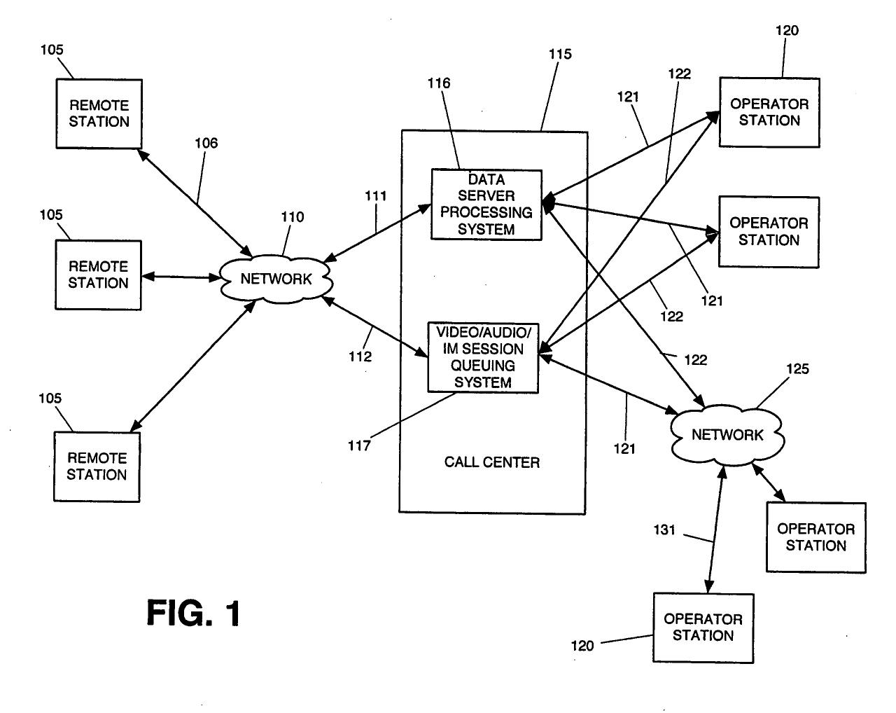

FIG. 1 is an example schematic illustration according to an embodiment of the inventive subject matter described herein. FIG. 1 depicts a system for the processing of candidates. In one embodiment, processing includes without limitation, screening, interviewing, testing and hiring, wherein the candidate is a candidate for a job or other placement opportunity. A candidate uses a Remote Station 105 for interacting with processing personnel using the Candidate Processing System 115. In one embodiment the Remote Station 105 is positioned at a geographic location that is convenient to the candidate such as, without limitation, retail store locations, job placement centers, government sponsored workforce centers, corporate headquarters and locations satellite to a corporate headquarters, private locations and public locations. In a further embodiment, the Remote Station 105 may be deployed through an Internet-enabled user interface that can executed on a computer located in a candidates home or other location.

In one examplee embodiment the Remote Station 105 is configured to capture and transmit images and text from the candidate to the Candidate Processing System 115 in real-time. The Remote Station 105 may include, without limitation, a video camera, a video output device, a data input device and a voice communications device. In another embodiment the Remote Station 105 is implemented in an Internet-capable user interface running on a computer, such as a web-based interface using HTML, XML, Flash or any other suitable technology or software for implementing a web-based interface. In such an embodiment, the Remote Station may not include a video camera. In yet another embodiment, a data input device and a video output device are the minimum requirements for a Remote Station 105, though further components, such as a voice communications device and a video camera, may also be present.

The Remote Station 105 connects to systems or devices that are part of the Candidate Processing System 115 through a Network 110. In an embodiment, the Remote Station sends information to the Candidate Processing System 115 such as, without limitation, still or moving real-time images, IM information, real-time audio or voice information, and data items. In one example embodiment and not by way of limitation, the connection from the Candidate Processing System 115 to the Remote Stations 105, through a Network 110 for example, is divided into two components: a data link 111 and a video/audio/IM link 112. The data link 111 transmits data items from the Remote Station 105 to a Data Server Processing System 116. In an embodiment, the data items include, without limitation, employment form data, skills testing data, and personal identification data.

In one possible embodiment, the Data Server Processing System 116 is co-located with other components of the Candidate Processing System 115. In another embodiment, the Data Server Processing System 116 is physically located apart from other components of the Candidate Processing System 115. The video/audio/IM link 112 transmits images, audio and IM information acquired in real-time from the Remote Station 105 to a Video/Audio/IM Session Queuing System 117.

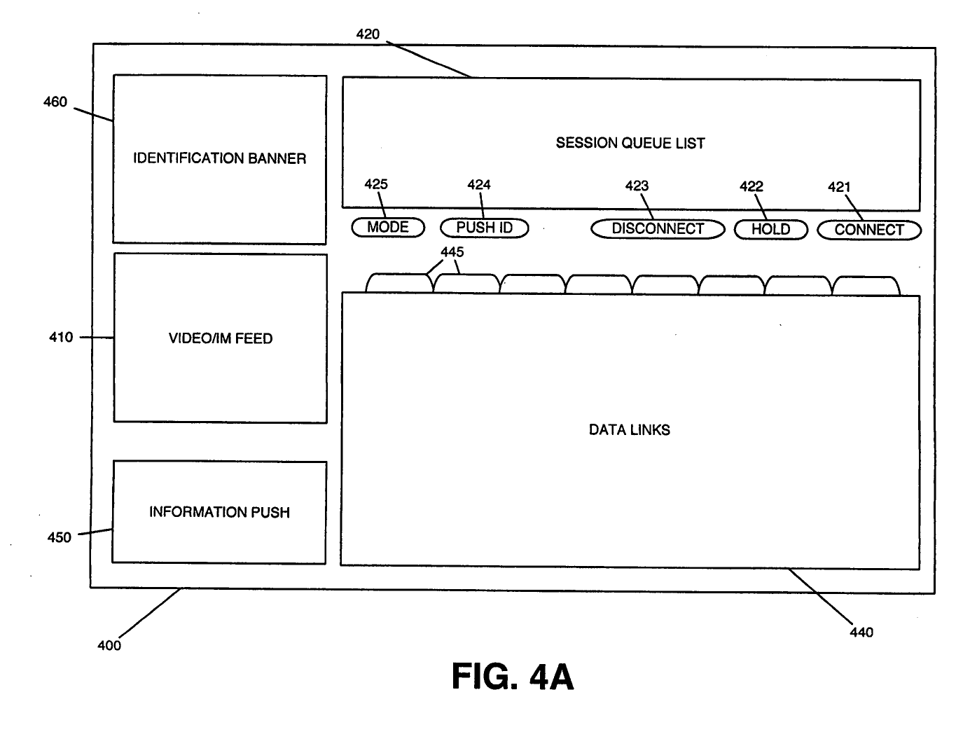

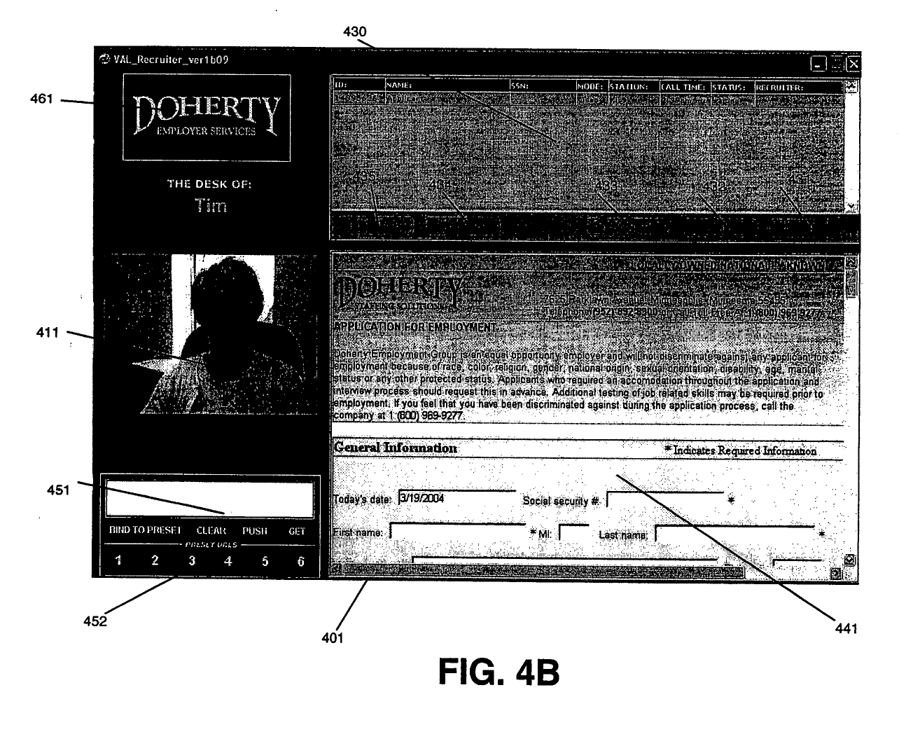

In one embodiment, the Video/Audio/IM Session Queuing System 117 is capable of handling multiple incoming sessions. The Video/Audio/IM Session Queuing System 117 queues up all requested sessions. The queued sessions are displayed to the operator serviced by the Candidate Processing System 115 in a user interface on the Operator Station 120. The user interface and display are discussed in more detail in FIG. 4A and FIG. 4B and the accompanying description contained below. An operator at an Operator Station 120 can choose one or more of the displayed sessions to service. The selected sessions are then designated ‘in process’ and become unavailable for other operators to select. In an embodiment, the Operator Stations 120 are physically co-located with some or all components of the Candidate Processing System 115. In another embodiment, the Operator Stations are located remotely from one or more of the Candidate Processing System 115 components and are connected with a Network 110 to the Candidate Processing System 115.

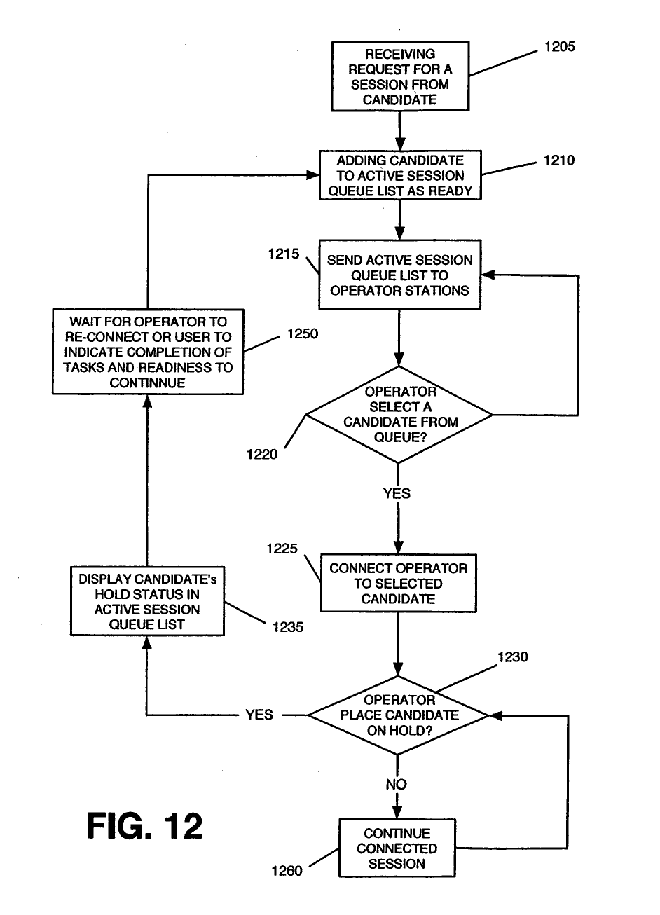

The Video/Audio/IM Session Queuing System 117 receives the video, audio or IM information that is acquired in real-time, and transmits it to the Operator Station 120 used by the operator that is servicing the candidate's processing. In an embodiment, an operator may service more then one candidate at a time, using the Video/Audio/IM Session Queuing System 117 to place candidates on hold or to receive other candidates' video sessions while the other candidates being serviced by the operator are performing other tasks, such as filling out forms, or performing skills tests. The functionality of the Video/Audio/IM Session Queuing System 117 is discussed in further detail in FIG. 12 and the accompanying description below. This arrangement provides efficient use of the operator's time, and also decreases average waiting time. It will be understood by those skilled in the art that the implementation of this system over a Network, provides additional capabilities. Though the Video Queuing System 117 is shown in FIG. 1 as co-located with operators or other components of the Candidate Processing System 115, it may be located elsewhere, remote from the operators or other components of the Candidate Processing System 115. Further, any logical arrangement where an operator is connected to a Video/Audio/IM Session Queuing System 117 and a Data Server Processing System 116, which are in turn connected to a Remote Station 105, is within the scope of the inventive subject matter described herein.

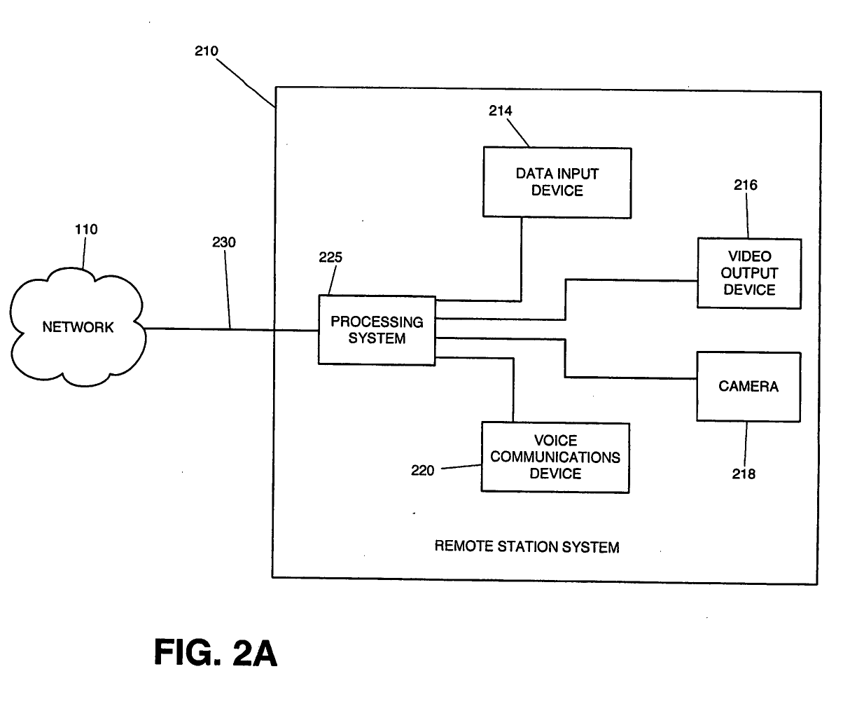

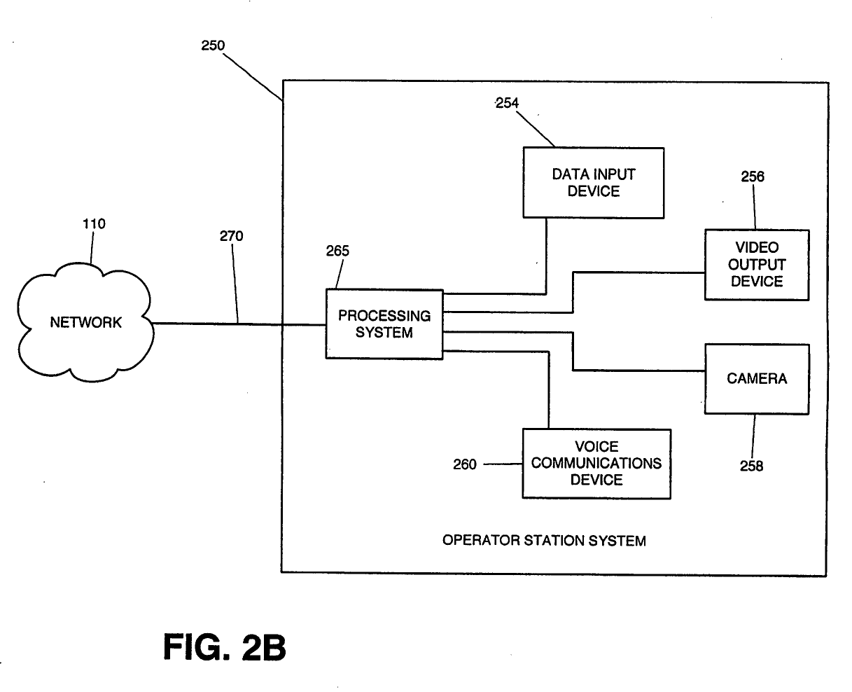

FIG. 2A is an example schematic illustration of a system according to an embodiment of the inventive subject matter described herein. FIG. 2A depicts a Remote Station System 210 such as that may be used at the Remote Station 105 of FIG. 1. The Remote Station System 210 contains, without limitation, a data input device 214, a video output device 216, an image capture device or camera 218, and a voice communications device 220. They are in turn connected to a processing system 225. The processing system 225 is connected to a Network 110, through a communications link 230. Processing systems typically comprise a central processing unit (CPU) and one or more software modules. In an embodiment the processing system handles both data transmission, such as textual entry of online forms, as well as video, audio and IM information acquired in real-time, such as that acquired by the camera, voice communications device or data input device. In another embodiment, separate processing systems are used for the handling of data items and video, audio and IM transmissions. The data input device may include, without limitation, a keyboard, trackpad, trackball, touch-sensitive video screen, voice recognition device, as well as any other device capable of receiving data from a user. In still another embodiment, the camera is a device capable of actively capturing video data, such as the likeness of the candidate. Alternatively, the camera is a device capable of capturing a series of still pictures that are sent and displayed in series, approximating a video stream, such as the likeness of the candidate.

FIG. 2B is an example schematic illustration of a system according to an embodiment of the inventive subject matter described herein. FIG. 2B depicts an Operator Station System 250 such as that may be used at the Operator Station 120 of FIG. 1. The Operator Station System 250 contains, without limitation, a data input device 254, a video output device 256, an image capture device or camera 258, and a voice communications device 260. They are in turn connected to a processing system 265. The processing system 265 is connected to a Network 110, through a communications link 270. Processing systems typically comprise a central processing unit (CPU) and one or more software modules. In an embodiment, the processing system handles both data transmission, such as textual entry of online forms, as well as video, audio and IM information acquired in real-time, such as that acquired by the camera, voice communications device and data input device, respectively. In an embodiment, separate processing systems are used for the handling of data items and video and audio transmissions. In an embodiment, the data input device 254 includes, without limitation, a keyboard, trackpad, trackball, touch-sensitive video screen, voice recognition device, as well as any other device capable of receiving data from a user. In an embodiment, the camera 258 is a video camera capable of actively capturing video data, such as the likeness of the candidate. In still another embodiment, the camera 258 is a still camera capable of capturing one or more still pictures, approximating a video stream, such as the likeness of the candidate.

As indicated above, the example configurations of the inventive subject matter described herein provide that job candidates can interact with processing personnel through the Candidate Processing System 115. The candidates and processing personnel can be located any distance apart, either closely proximate one another or greatly remote from one another. The location of the Candidate Processing System 115 is not important, nor is it important that the components of the Candidate Processing System 115 be co-located with each other or with processing personnel. This architecture allows maximum flexibility, allowing candidates and processing personnel to communicate with each other from any respective desired location, provided that they have access to the necessary remote stations or operater stations.

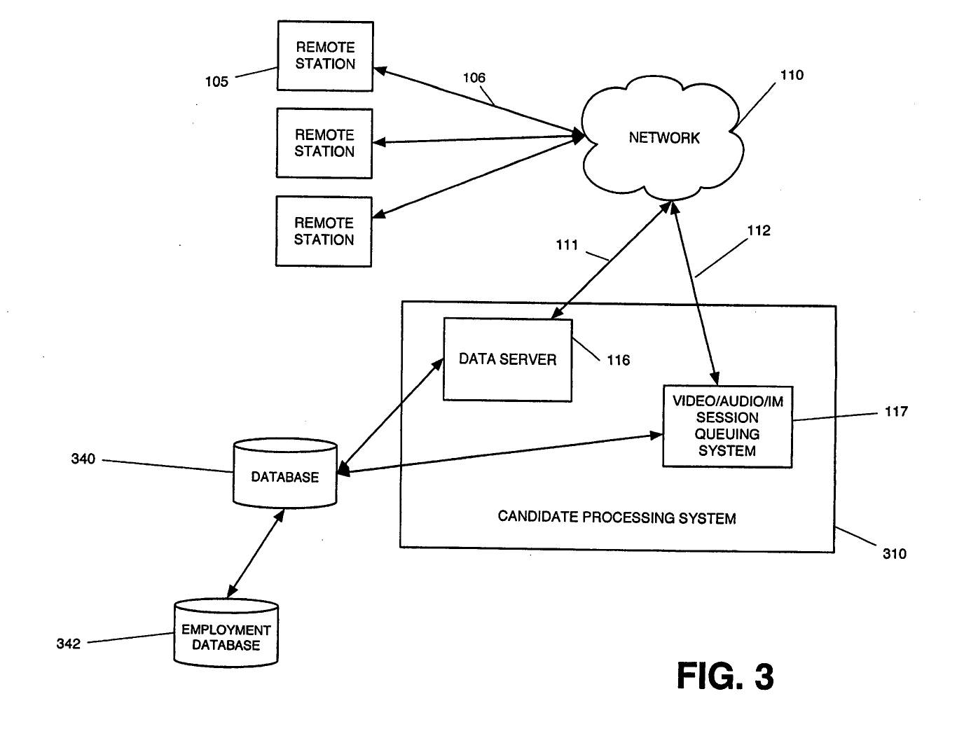

FIG. 3 illustrates example data structures according to an embodiment of the inventive subject matter described herein. In this embodiment, the Data Server Processing System 116 connects to a database 340 that contains candidate information including for example candidate skills information. In yet another embodiment, the database 340 connects to other databases, such as an employment database 342. In a further embodiment, the Video/Audio/IM Session Queuing System 117 connects to the database 340 for adding and retrieving information about candidates.

FIG. 4A is an illustration of an example user interface according to an embodiment of the inventive subject matter described herein. FIG. 4A shows an example screen 400 of a user interface that could be presented to an operator at an operator station 120, such as depicted in FIG. 1. The Video/IM Feed 410 section of the screen 400 presents the actively captured images from the Remote Station 105 being used by the candidate being presently processed. In one example embodiment, the Video/IM Feed 410 section may display IM data as the candidate has chosen to interact with the operator using IM. The Session Queue List 420 section of the screen 400 displays various information about the candidates currently connected to the Video/Audio/IM Session Queuing System 117. In an embodiment, the displayed information includes, without limitation, Candidate Unique Identifier Number, Candidate Name, Candidate Social Security Number, Interactive Mode, Station ID, Time of Session, Candidate Status, and Operator. The Candidate Unique Identifier Number is any number that is uniquely assigned to that candidate. In an embodiment, this unique identifier may be retained across multiple sessions. In another embodiment, the unique identifier is not retained. The Interactive Mode is an indication as to whether the candidate is interacting via Video or IM. In an embodiment, when the interactive mode is video, then audio is enabled. In a further embodiment, when the interactive mode is IM, audio is optional. The Station ID is a unique identification of the location of the station, such that the operators connected to the Video/Audio/IM Session Queuing System have a visual indication as to the location of the Remote Station 120 being used by the candidate. Time of Session indicates to the Operators when the candidate first connected to the system. Candidate Status indicates whether the candidate is being presently processed, waiting to interact with an operator or supplying data. In an embodiment, if the candidate is on hold, the Candidate Status is color coded as to the time that the candidate has been on hold. In such an embodiment, when a candidate has been on hold longer then a pre-determined amount of time, their Candidate Status can be displayed in bolded red, for example. Operator indicates which operator is currently processing that candidate. If no operator is displayed, the candidate is waiting to be connected to an operator.

The operator can choose to interact with the candidate through selecting by various means. In an embodiment, the operator, through a selecting device or mechanism can choose to process a candidate, such as by clicking a mouse button while the screen cursor is over that candidate's information in the Session Queue List 420 section of screen 400. Alternatively, the operator can choose to select the candidate by highlighting their name in the Session Queue List 420 and selecting the Connect 421 button of screen 400. In an embodiment, when the operator is currently connected to a candidate, they can choose to place that candidate on hold by selecting the hold 422 button of screen 400. In a further embodiment, when the operator is currently connected to a candidate, they can choose to disconnect from that candidate by selecting the Disconnect 423 button of screen 400.

The Data Links 440 section of screen 400 provides the operator the ability to view information related to the candidate, such as a candidate profile. For example, the operator may elect to examine the present candidate's skills test scores or their past employment history. In an embodiment, access to the various portions of the candidate's file are accessed via a number of tabs 445 provided in proximity to the Data Links 440 section of screen 400. Each tab may represent a single portion of the candidate's file. In an embodiment, each tab may represent categories of information and when displayed, may provide further tabs providing access to individual documents in the candidate's file.

The Information Push 450 section of screen 400 provides the operator the ability to send informational links to the candidate they are presently processing. These may include, without limitation, links to websites, links to online data entry forms, links to documents that the candidate should read. In an embodiment, the Information Push 450 section of screen 400 has a plurality of buttons providing to the operator a selection of pre-set informational links, such that the operator does not have to enter a location of the link before providing it to the candidate. The Identification Banner 460 section of screen 400 provides the Candidate Processing System Operator the ability to display information to the operator processing candidates.

FIG. 4B is an example of an implementation of a user interface according to FIG. 4A. In this example, the candidate ‘Applicant’ is currently connected to the Video/Audio/IM Session Queuing System. They are currently waiting to be processed and they have been connected since 2:39 P.M. The operator can choose to highlight them, such as with a mouse or other input device, and then connect to them by selecting the connect button 431. The present candidate's application form can be displayed in the data links section 441. As discussed above, the Video/IM Feed section 441 of the screen 401 shows an image of the candidate acquired in real-time. Alternatively, if ‘Applicant’ had chosen to interact with IM instead, the image would be replaced with an IM chat interface such as is well known in the art. The Information Push section 451 provides the operator the ability to type in a link to information. Alternatively, the Preset URL's 452 section can be used to quickly access the most often used links.

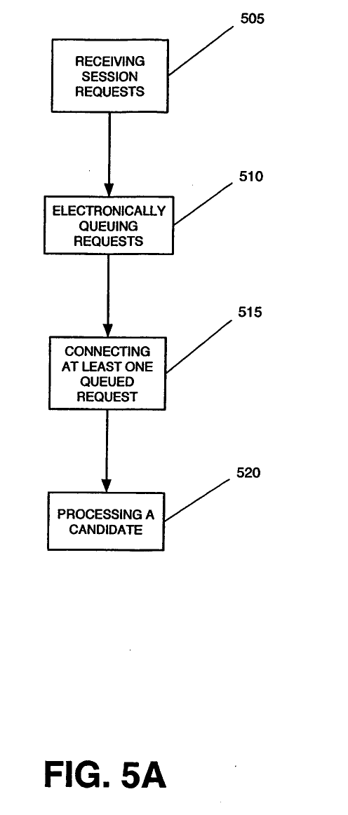

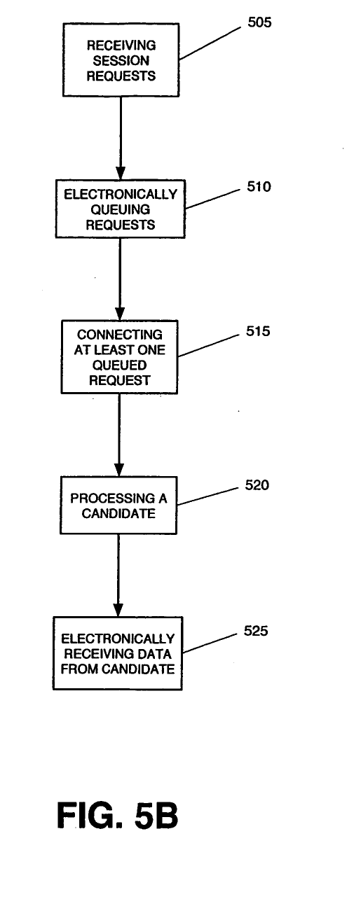

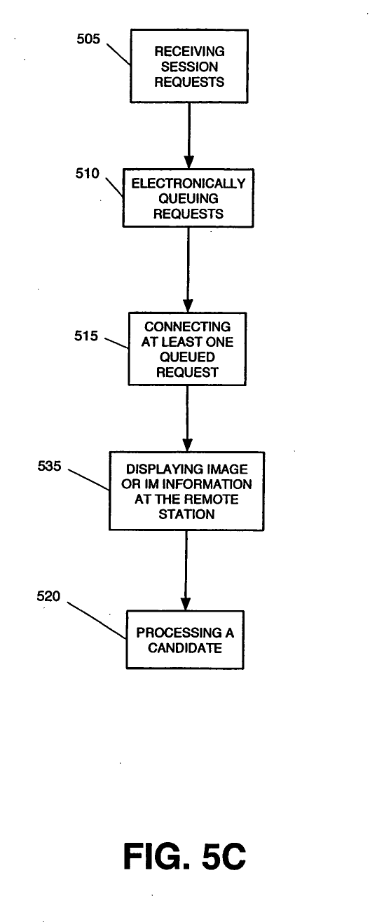

FIG. 5A depicts at a high level a method for carrying out the processing of a candidate according to an embodiment of the inventive subject matter described herein. At 505 the system receives at least one session request. These session requests represent a candidate requesting processing as contemplated herein. The system, such as the Video/Audio/IM Session Queuing System 117 of FIG. 1 electronically queues those requests at 510 for handling by operators. The Video/Audio/IM Session Queuing System 117 connects at least one of the session requests with at least one of the operators that are currently available on the system. In an embodiment the Video/Audio/IM Session Queuing System 117 connects more than one session with a single operator such that a single operator is able to handle sessions with more then one candidate at a time. At 520 the operator processes the candidate. In an embodiment, processing includes, without limitation, screening, interviewing, testing, and hiring. In an embodiment candidate includes, without limitation, a job applicant, a contractor applying for a new assignment, an employee seeking promotion, and a temporary employee of a temporary agency requesting a new assignment.

FIG. 5B is a flowchart of a method according to an embodiment of the inventive subject matter described herein. FIG. 5B depicts a similar method as FIG. 5A with the addition of electronically receiving data from the candidate, such as at 525. In an embodiment, this data includes, without limitation, employment form information, skills testing and personal identification data. In FIG. 5B this is depicted following the processing of a job candidate. This may be done while an operator is processing a candidate, such that the operator begins processing and during processing identifies a need to screen the candidate for specific skills. In such an example, the operator can assign a specific skills test to the candidate if required, and while the candidate performs the skills test, the operator handles other calls and when the applicant is finished, the operator can return to the candidate to finish processing. In a further embodiment, an operator other than the operator who began processing the candidate can select to further process the candidate. Alternatively, the candidate can provide data prior to initiating a session request. In an embodiment, the candidate when first entering in identification data is prompted to fill our various forms. In such an embodiment, electronically receiving data from the candidate such as contemplated at 525 happens prior to receiving session requests such as contemplated at 505.

FIG. 5C is a flowchart of a method according to an embodiment of the inventive subject matter described herein. FIG. 5C depicts a method similar to those of FIG. 5A and FIG. 5B. The Remote Station 105 transmits video, audio and IM information acquired in real-time over its communications link to the Video/Audio/IM Session Queuing System 117. The Operator Station 120 receives the video, audio and IM information acquired in real-time display that information at 535.

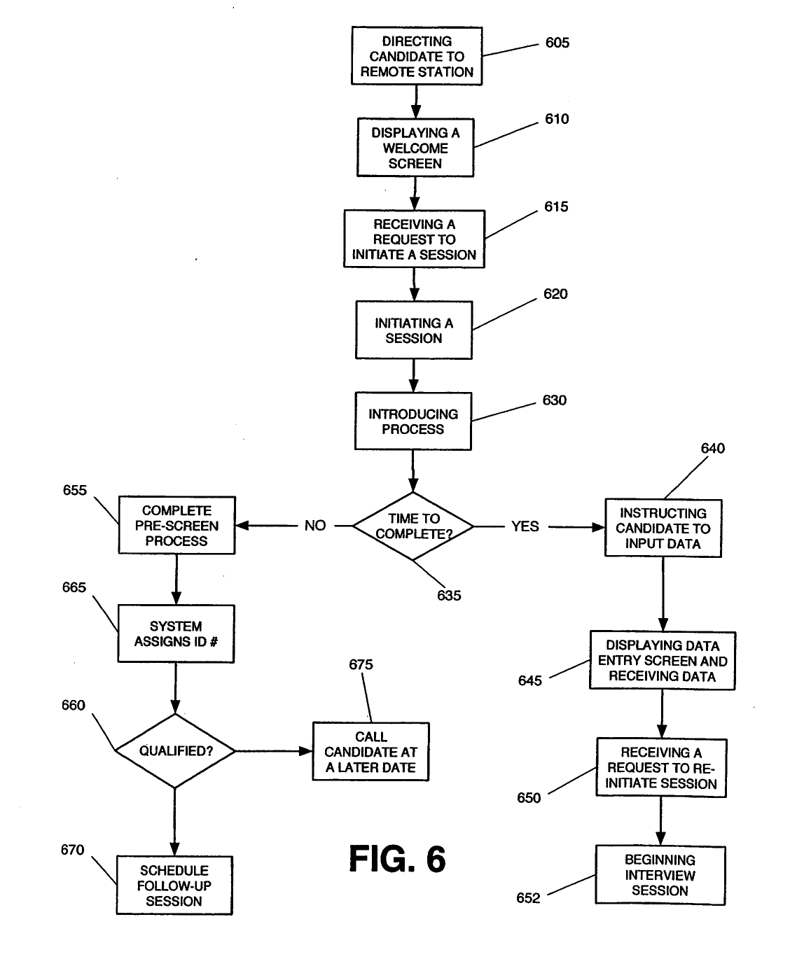

FIG. 6 is a flowchart of a method according to an embodiment of the inventive subject matter described herein. FIG. 6 depicts a method of processing a candidate. At 605 the candidate is directed to a remote station, such as that depicted in FIG. 1. In an embodiment Remote Station is meant to refer to any location or terminal that a candidate can use to undergo processing according to the embodiments of the inventive subject matter described herein. This includes without limitation, stations at locations remote to the Candidate Processing System 115, stations located at the Candidate Processing System 115, or an internet-enabled virtual remote station accessed via the candidate's home computer. It is to be understood that the term virtual is used as only a useful descriptor, and what is meant is some Internet-enabled application that would substantially perform the functions of the Remote Station 105 depicted in FIG. 1. As such this virtual remote station would be able to acquire video, audio or IM information in real-time. The candidate could be directed to a Remote Station, or internet-enabled virtual remote station, via marketing materials, or by a customer service representative of the organization that the candidate is presenting themselves to. These are only meant as examples, and as more methods of marketing the remote stations are possible; any method of making a potential candidate aware of the Remote Stations, either physical remote stations or Internet-enabled Remote Stations, is considered within the scope of the inventive subject matter described herein.

At 610 the Remote Station displays a welcome screen to the candidate. The candidate wishing to be processed indicates at the Remote Station that they wish to initiate a session with an operator. The indications may include, without limitation, clicking on a screen or touching the screen. The Video Session Queuing System, such as that depicted in FIG. 1, receives a request to initiate the session from the Remote Station and further initiate such a session 620 when an operator selects the candidate out of the queue. At 630, the operator introduces the process and explain it to the candidate. After an explanation of the process to the candidate, the operator may inquire as whether the candidate has time to complete processing at 635. If the candidate does have the time to complete processing, the operator may instruct the candidate at 640 as to what data is required and further instruct them as to the steps needed to complete the entry of such data. The Remote Station may display a data entry screen to the candidate at 645 and transmit the data that is entered by the candidate to a data server, such as the Data Server Processing System 116 depicted in FIG. 1. During the candidate's entry of data at the Remote Station, the operator may place their video session on hold, and process other candidates in the queue. Following their input of the required data, the candidate may indicate that they are ready to re-initiate a session with an operator and that system may receive that request at 650. In an embodiment, the operator that was handling the candidate previously may re-connect with that candidate. In an embodiment, any operator currently connected to the Candidate Processing System 115 can connect with the candidate for further processing.

If the candidate is not able to complete processing at 635, the operator can complete a pre-screen process at 655 and make a determination as to whether the candidate is qualified to be further considered by the organization at 660. Following the completion of the pre-screening process at 655, the operator may assign an ID # to the candidate at 665 so that the candidate may be able to be identified the next time they use the system. In an embodiment, the ID # is a 6 digit security code. If the determination at 660 is that the candidate is qualified for further processing, such as additional skills testing or specific screening, the operator can schedule a follow-up session at 670. If the determination at 660 is that the candidate is not qualified, the operators may choose to inform the candidate that they may be called for further processing for another possible position at a later date at 675. In an embodiment, no determination is made at 660 and all candidates that complete the pre-screening process can be scheduled for a follow-up session. In an embodiment, no determination is made at 660 and all candidates are informed that they may be called at a later date at 675 for further processing. In an embodiment, scheduled for further processing at 670 includes positively scheduling further processing, such that the operator schedules an appointment at a specific time and date that the candidate may continue processing.

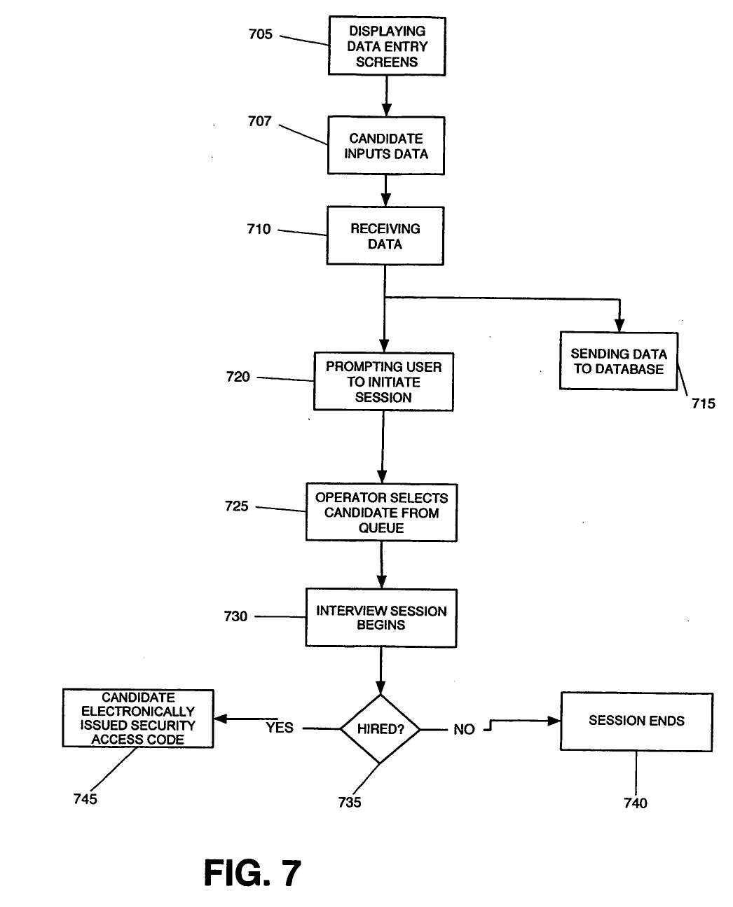

FIG. 7 is a flowchart of a method according to an embodiment of the inventive subject matter described herein. FIG. 7 is an example of a method where the user must supply some data before being allowed to initiate a session with an operator. In an embodiment, the data includes, without limitation, personal identification data, employment forms, employment history information, skills proficiency information, or skills testing. This provides the benefit of pre-screening candidates before they are added to a queue of candidates, increasing the efficiency of the operators of the system. At 705 a data entry form is displayed to the user. As the data required may be the completion of a skills test, for example, the data entry form may include the performance of certain steps by the candidate, other than the mere supplying of data. The candidate inputs the data required at 707. At 710 the Remote Station receives the data from the candidate and may subsequently send that data entered to a database at 715. At 720 the Remote Station may prompt the candidate to initiate a session. In an embodiment, the candidate re-initiates a session in which the candidate had previously been or was in the process of being processed by an operator when they were required to submit additional data to the system. Following the initiation of a request for a session, the Video/Audio/IM Queuing Session System may add the candidate to the queue and an operator can select that candidate from a queue of all candidate session requests at 725. At that point, the operator can begin an interview session at 730. After such an interview, the operator makes a determination as to hiring the candidate at 735. In an embodiment, the candidate is not hired, but is selected for further processing. If the candidate is not hired, the session may end at 740. If the candidate will be hired or selected for subsequent processing, the candidate is assigned a security code at 745. This security code can be used by the candidate to identify themselves for future processing, speeding up such future processing.

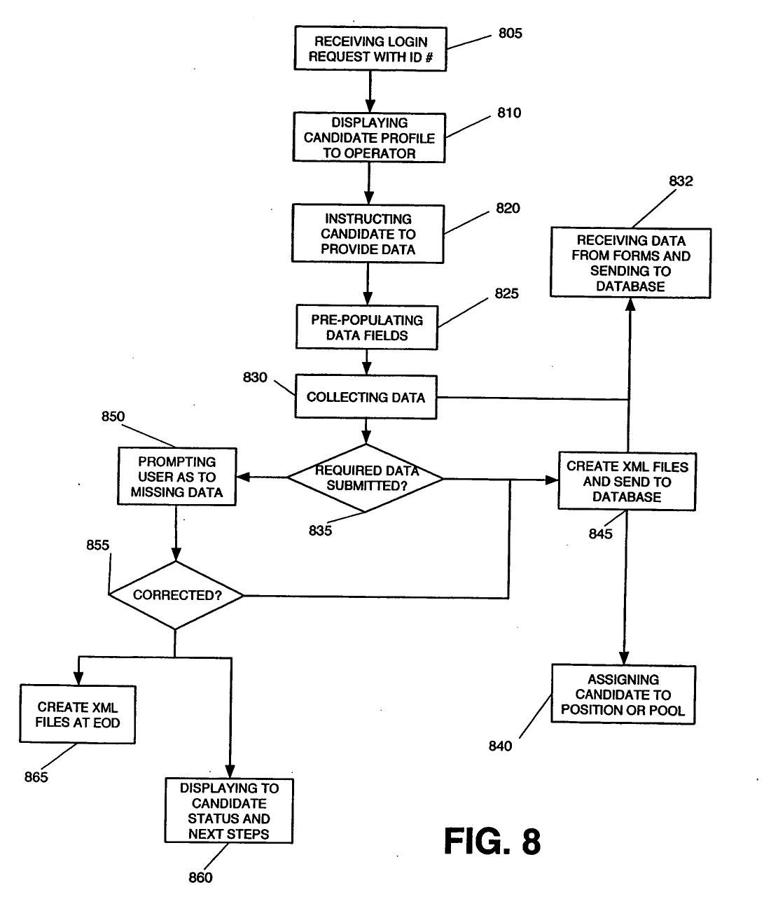

FIG. 8 is a flowchart of a method according to an embodiment of the inventive subject matter described herein. FIG. 8 depicts a method where the candidate has already gone through some processing, such as that depicted in FIG. 6 or FIG. 7. The candidate has some ID # that they input into the Remote Station at 805. A session is initiated and the candidate is placed in the queue by the Video Session Queuing System and made available to operators connected to the Video Session Queuing System. In an embodiment, when the operator preliminarily selects the candidate from the Session Queue List section 420 of screen 400, such as that depicted in FIG. 4A, the candidate profile can be displayed to the operator at 810 in the Data Links section 440 of their screen 400. Though reference is made to the user interface screen of FIG. 4A this is not meant to be exclusionary of any other user interface screen where the operator is presented candidate data. After viewing the candidate profile at 810, the operator determines if any additional data is needed and instructs the candidate to provide such data at 820 if required. In such an example, the candidate's online data entry forms may be pre-populated with any data that they previously supplied to the system. The Remote Station collects the data at 830 and transmits that data to a data server, such as the Data Server Processing System 116 depicted in FIG. 1. The Data Server Processing System receives the data and further sends that data to some database at 832. At 835 the operator again examines the profile of the candidate and ensures that all the required data has been submitted. If such is the case, the operator can now assign the candidate to a position or to a pool at 840. In parallel to assigning the candidate at 840, the operator indicates that the user data is complete to the system and the system is able to create XML files which can then be sent to a data server.

If all the required data is not submitted as determined at 835, the operator can prompt the candidate as to the missing data at 850. A check is made as to whether the missing data has been corrected at 855. If it has been corrected, the processing of the candidate proceeds similarly as if they had submitted the required data at 835. If the error has not been corrected, the system displays to the user at their Remote Station their current status at 860. Additionally the operator at 860 can explain to the candidate their next steps for further processing. In an embodiment, the next steps may be that the candidate needs to obtain further information or undergo skills training. When required data is not submitted as determined at 855, information obtained is maintained in the system and submitted to a data server as XML data at the End of the Day (EOD) at 865.

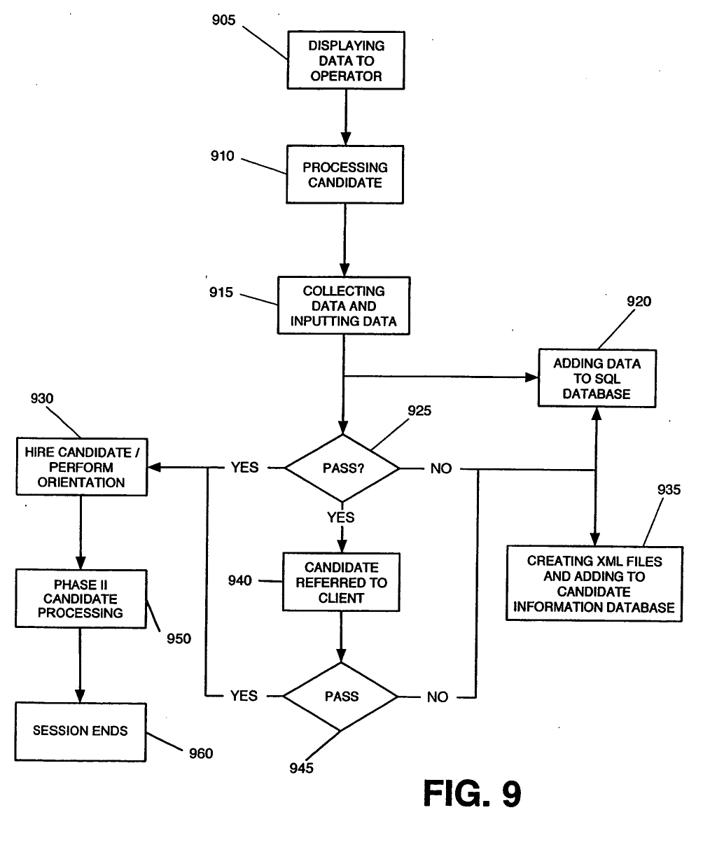

FIG. 9 is a flowchart of a method according to an embodiment of the inventive subject matter described herein. At 905 candidate data is displayed to the operator. The operator further processes the candidate at 910. The operator collects data during the processing and inputs that data into the system at 915. The data inputted is sent to a data server where that data is added to a database. At 925 the operator makes a determination as to whether the present candidate has passed processing. If the candidate has passed processing, the operator may hire the candidate at 930 and begin the orientation process of the present candidate. In an embodiment, the operator refers the candidate to a client(s) that has contracted the services of the Candidate Processing System for the screening of its candidates. In such an embodiment, the candidate is referred to that client(s) at 940. Following such a referral, a determination is made by the client as to whether to hire the candidate at 945. If they decide to hire the candidate, they can contract to have the further processing of the candidate, such as that beginning at 930, performed by the Candidate Processing System and its personnel. If the candidate is not to be hired or referred to a client their information is input into the system and sent to a data server.

Following a decision to hire a candidate, the operator may begin to perform the orientation of that candidate at 930. In an embodiment, additional procedures must be performed before the candidate begins work or shortly after their beginning work. These procedures include, without limitation, background checks, reference checks, credit checks, drug testing, criminal record checks, lien checks, etc. These additional procedures are performed at 950. In an embodiment, these additional procedures are called Phase II Candidate Processing.

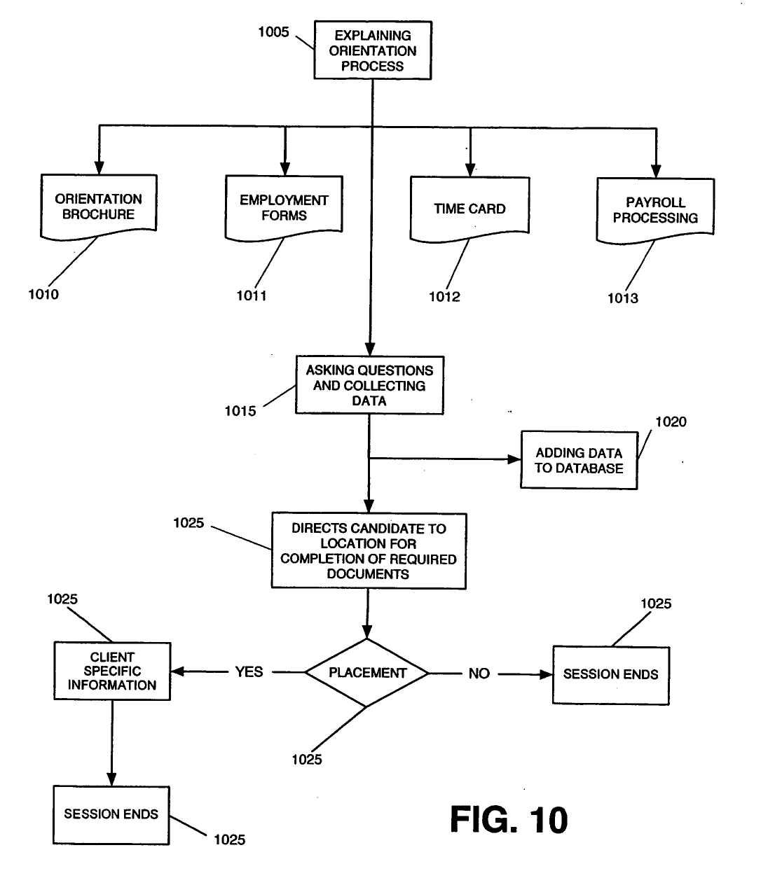

FIG. 10 is a flowchart of a method according to an embodiment of the inventive subject matter described herein. At 1005 the operator explains the orientation process to the candidate, such as the candidate that has successfully passed processing as detailed in FIG. 9. As part of the orientation process the operator explains the various documents that are part of an orientation package. In an embodiment, these include, without limitation, an orientation brochure 1010, employment forms 1011, time card 1012 or payroll processing 1013. In an embodiment, some forms are neglected as the successful candidate may not be a direct hire. The operator asks further questions of the now successfully processed candidate at 1015 and collect data as to those answers. The operator inputs that data into the system and it is sent to the Data Server Processing System for addition to a database at 1020. In an embodiment, the database is a SQL database. In an embodiment, the database is any database with relational storage and retrieval of data items. At 1025 the operator then directs the now successfully processed candidate to some physical location for completion of forms that cannot be filled out via a computer. In an embodiment these forms include, without limitation, 1-9 Immigration forms, or W-4 IRS Withholding forms. Following completion of the required forms, if the candidate is to be placed at a client site, additional information that is specific to the client is collected at 1025.

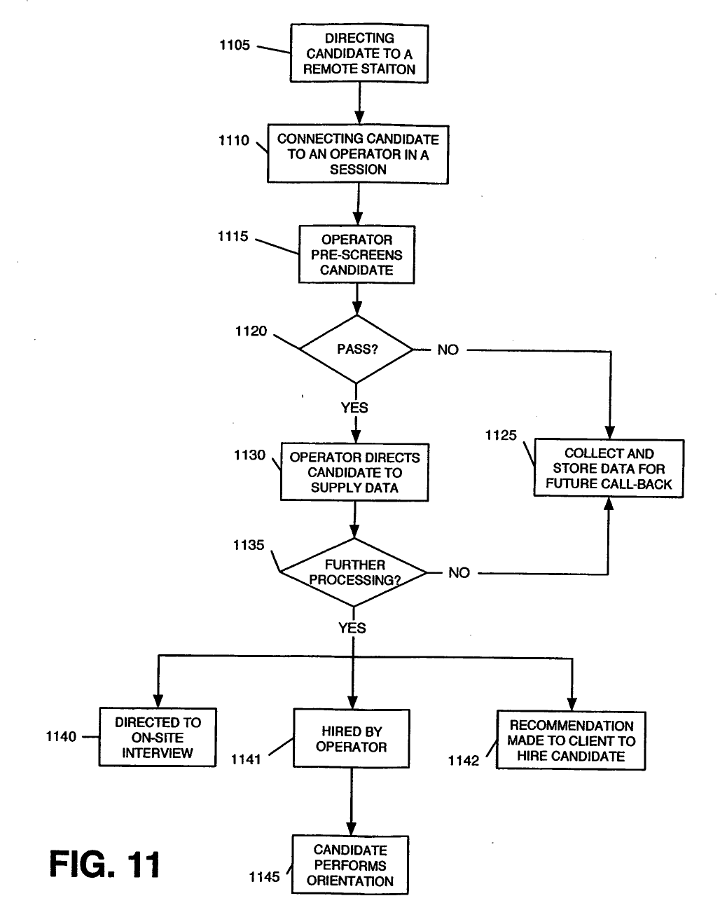

FIG. 11 is a flowchart of a method according to an embodiment of the inventive subject matter described herein. FIG. 11 depicts at a high level the processing of a candidate according to an embodiment. At 1105 a candidate is directed to a remote station. As discussed above, this remote station may be physically located or be virtually contained in a computer accessible to the candidate. At 1110 that candidate is connected to an operator servicing a Candidate Processing System and a session is initiated. The operator pre-screens the candidate based on some criteria at 1115 and makes a determination at 1120 whether to proceed with further processing. If further processing is not called for, data about the candidate is collected and stored in a database for future call-back at 1125. If further processing is needed, the operator can direct the candidate to supply the required data at 1130. After the data is submitted and examined by the operator, another determination at 1135 is made as to whether further processing is warranted. If not, the data is collected and added to the database at 1125. If the operator determines that further processing is warranted, several options are available. These options include, without limitation, being directed to an on-site interview 1140, hired directly by the operator 1141, recommending to a client that a hire be made 1142, etc. If the candidate is hired by the operator, the operator can then give an orientation to the candidate at 1145.

FIG. 12 is a flowchart of an example method of operation of a system, such as the Video/Audio/IM Queuing System 117 depicted in FIG. 1. The system receives a request for a session at 1205. The system captures various information about the candidate, the remote station they are located at, time, etc. The system may retrieve this information automatically, such as in the case of the remote station location, from the candidate, such as in the case of the candidate's name, or from a database. The system adds the candidate to the active session queue list at 1210. That active session queue list is sent to the operator stations currently connected to the system at 1215. Information about the candidate is displayed on a user interface screen on the operator station, such as that depicted in FIG. 4A, with the information displaying in the Session Queue List 420 section of the screen being supplied by the system. Any operator connected to the system can choose to select the candidate at 1220. When an operator chooses to select a candidate, they are connected at 1225. During processing, the operator may place the candidate on hold. The candidate may be placed on hold to supply additional data. If placed on hold, the candidate's status is displayed as on hold in the active session queue list at 1235. At 1250 the operator presently processing the candidate may choose to re-connect to the candidate. Alternatively, any other operator can choose to connect to the candidate once the candidate has indicated that they have completed the task and are ready to re-initiate a session. In such an example, the candidate would be displayed in the active session queue list at 1210 with the ready status indicating to operators that the candidate is waiting for a session. At 1230 and 1260 the system continually monitors the connection for the operator to place the candidate on hold.

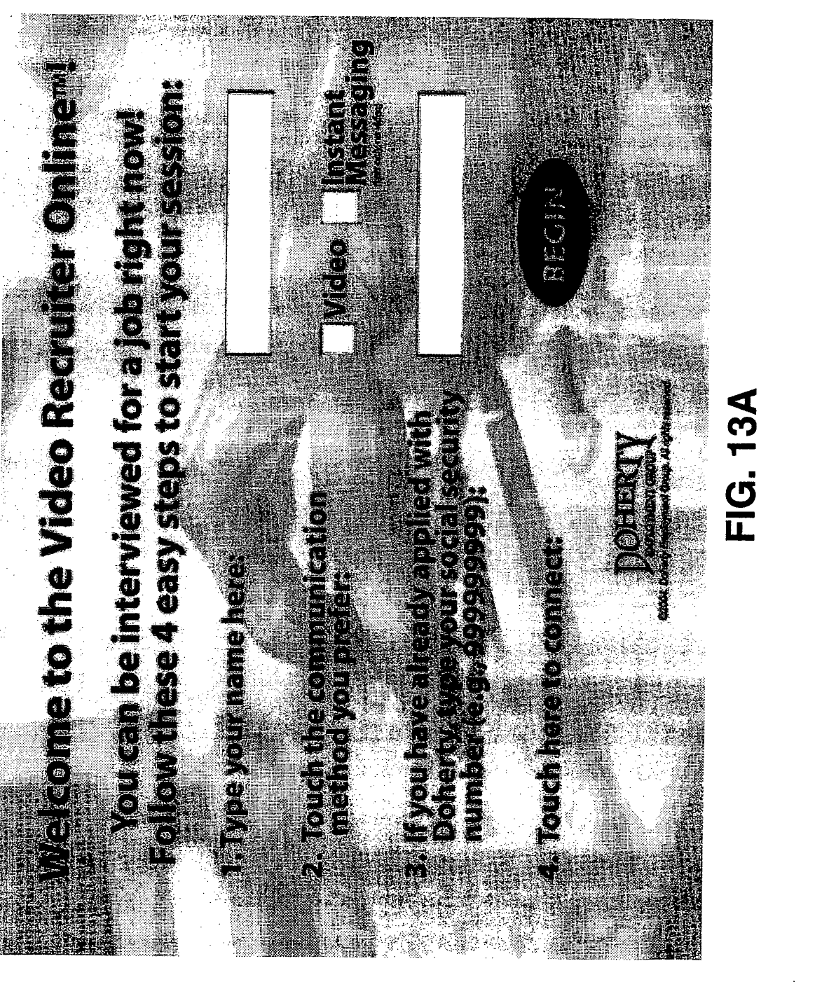

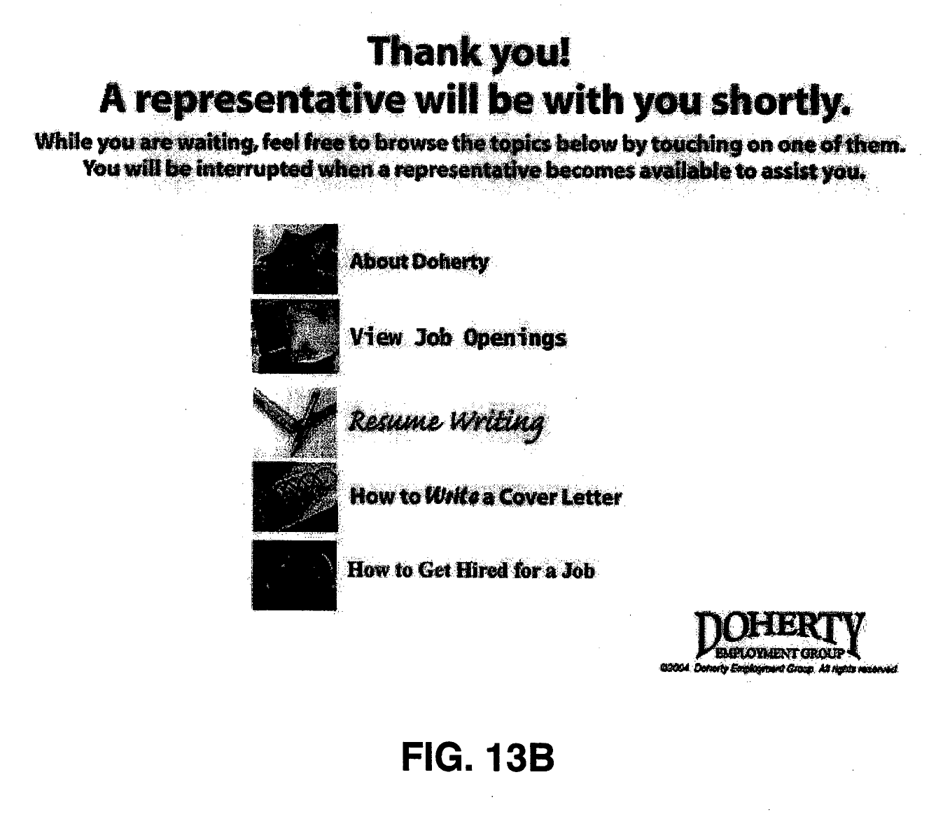

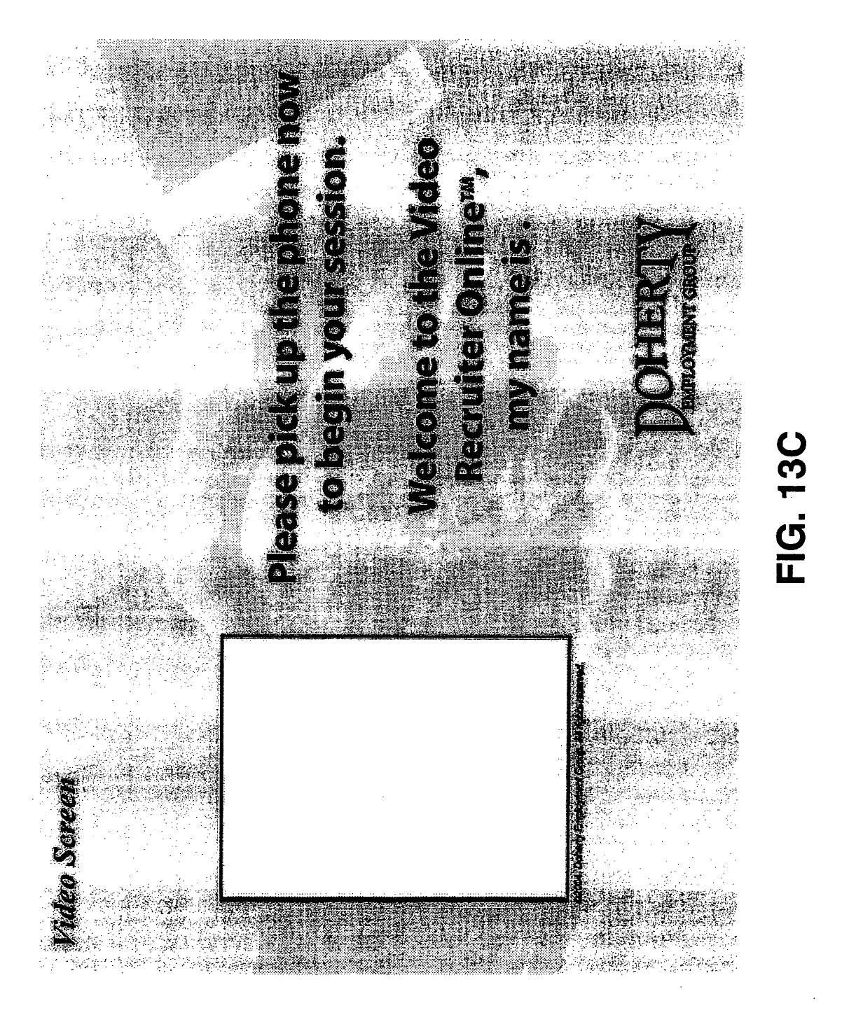

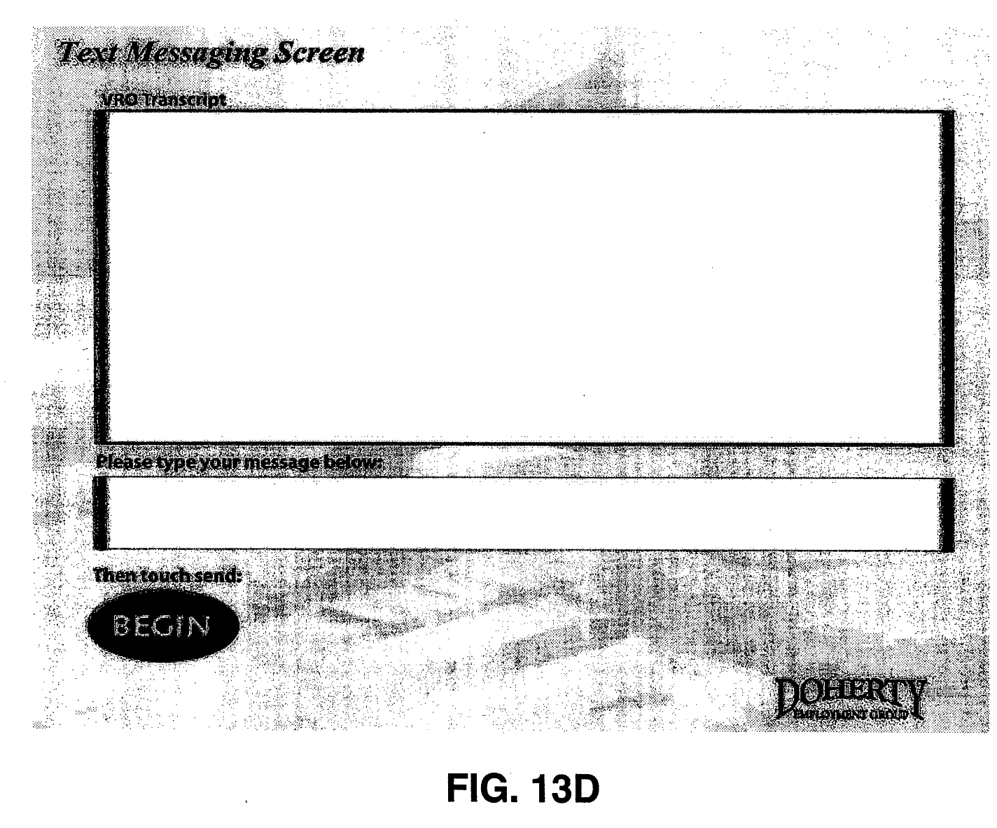

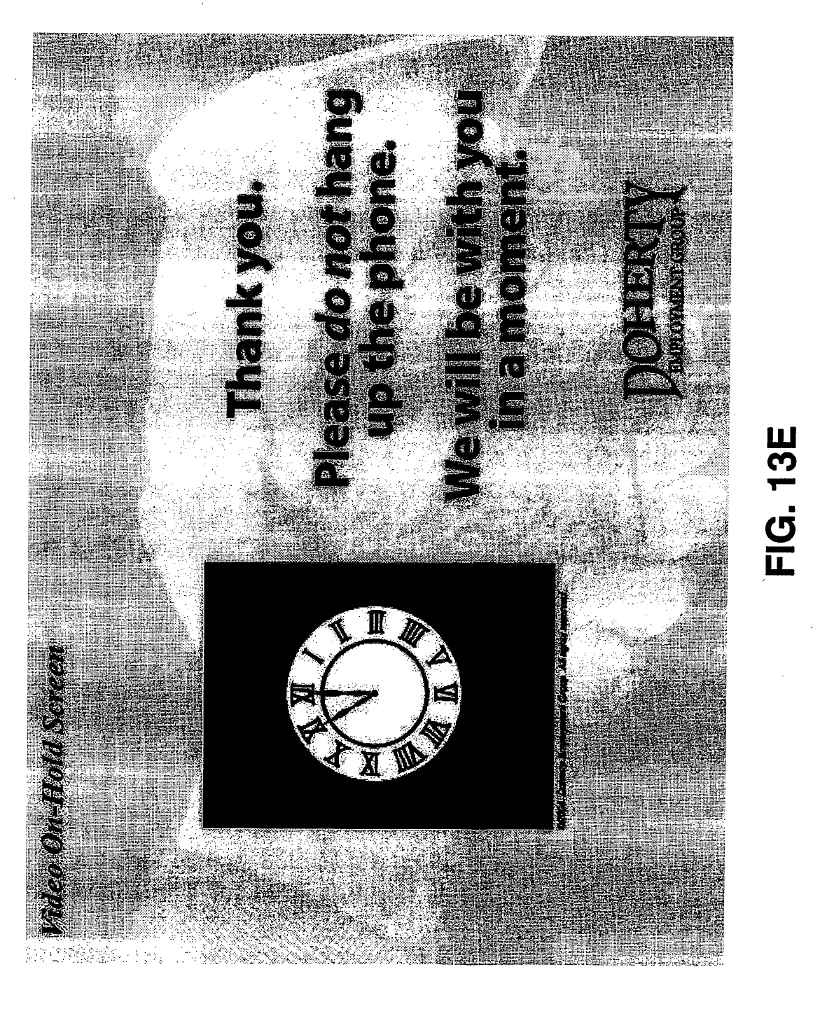

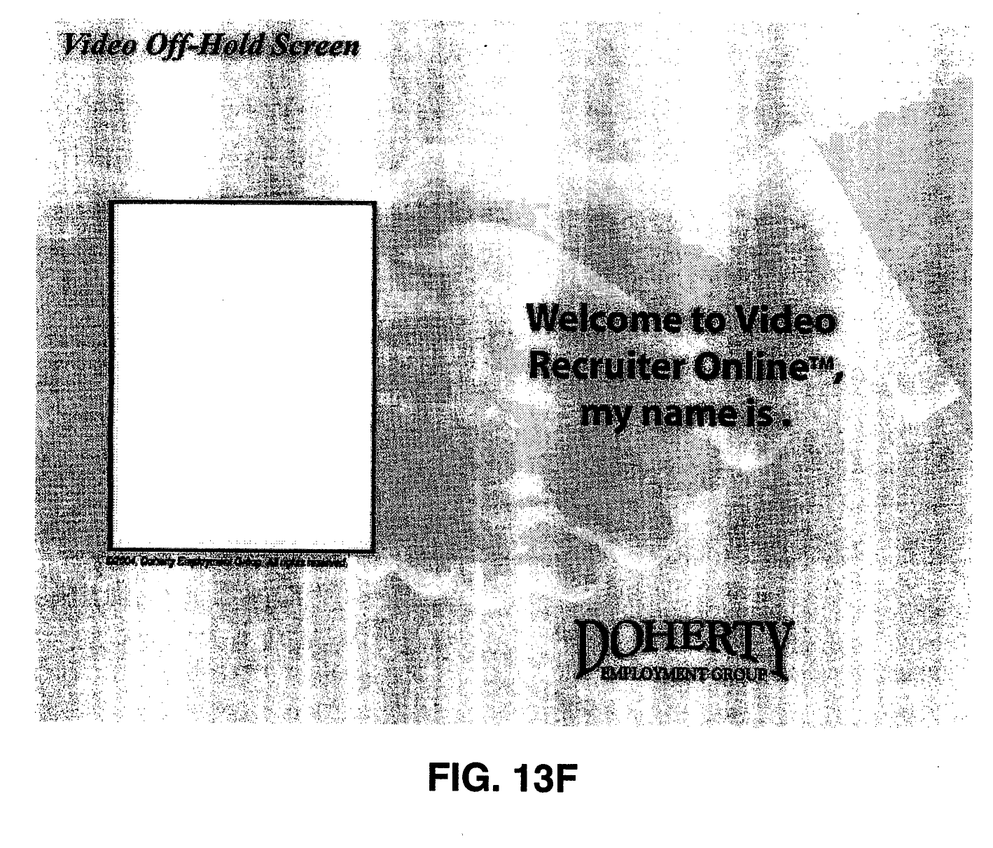

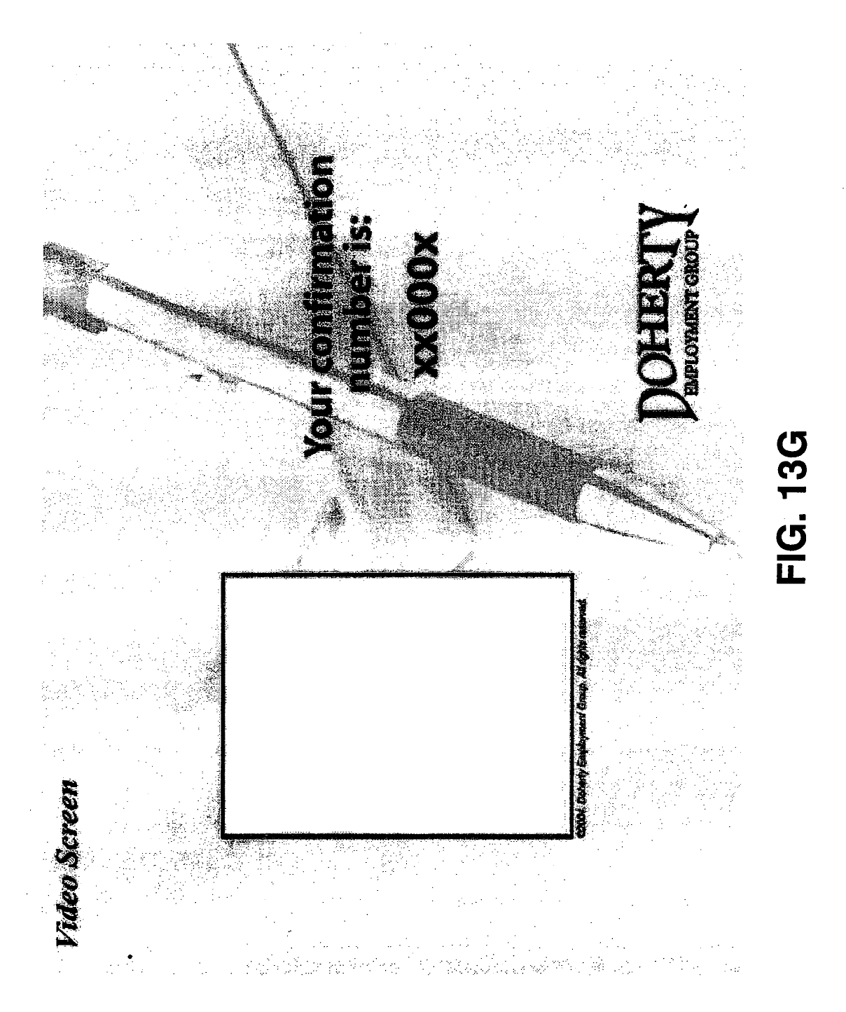

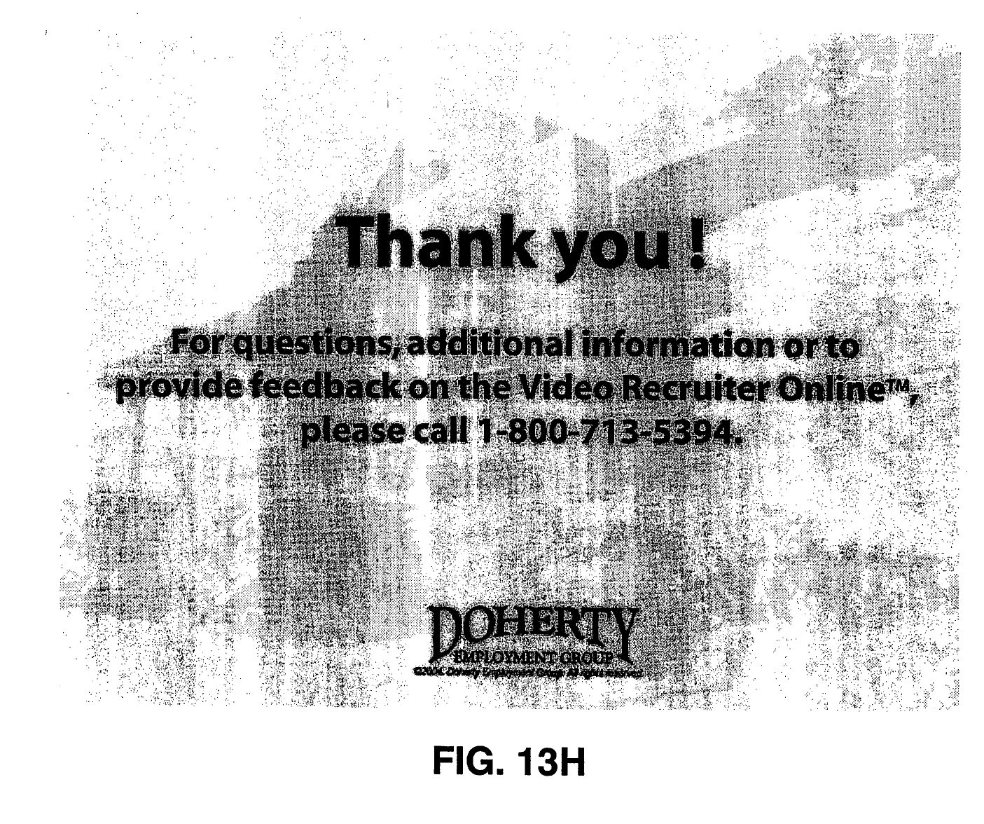

FIG. 13A-13H are screenshots of example user interface screens according to an embodiment of the inventive subject matter described herein. FIG. 13A shows a login screen, according to an embodiment, where the candidate is asked to supply their name as well as any identification number they may have previously been provided. In addition, the candidate is asked to select whether they wish to interact with video or instant messaging, or IM. If the candidate selected video, video is acquired in real-time with the camera at the remote station and audio is acquired in real-time with the voice communications device at the remote station. If the candidate selects IM, IM information is acquired in real-time. In a further embodiment, the voice communications device may be used when the candidate selects IM as the method of interaction. Following login to the system, the candidate may have to wait to be connected. FIG. 13B shows a screen that may be displayed while the candidate waits to be connected. Links may be provided to various information sources that the candidate can browse while waiting. Once connected, the candidate is presented a screen similar to FIG. 13C, showing a video image and a textual prompt to access the voice communications device. The video image is acquired in real time by the camera at the operator station such that the candidate is able to see the operator that is processing them. It is to be understood that the candidate is shown a video image only if they have chosen video as the method of interaction. If the candidate has chosen IM, they are displayed a screen similar to FIG. 13D. In such an example, the candidate uses the data input device to enter textual data to be exchanged with the operator. The operator enters textual data using the data input device on the operator station and such text is displayed to the candidate on the screen.

As there may be times when a candidate is placed on hold for extended periods of time, it would be advantageous to display to the candidate some indication that they are still connected. FIG. 13E depicts such an indication. This may be a clock or some cycling message being displayed on the screen. Once the candidate is taken off of hold a screen similar to FIG. 13F may be displayed. This is similar to FIG. 13C, though as the candidate is already using the voice communications device, it is unnecessary to re-direct them to do so. FIG. 13G is an example of a confirmation screen where the candidate is given some code to identify themselves with at some future session. FIG. 13H is an example of a closing screen, where the candidate is given information about how to provide feedback and pose future questions.

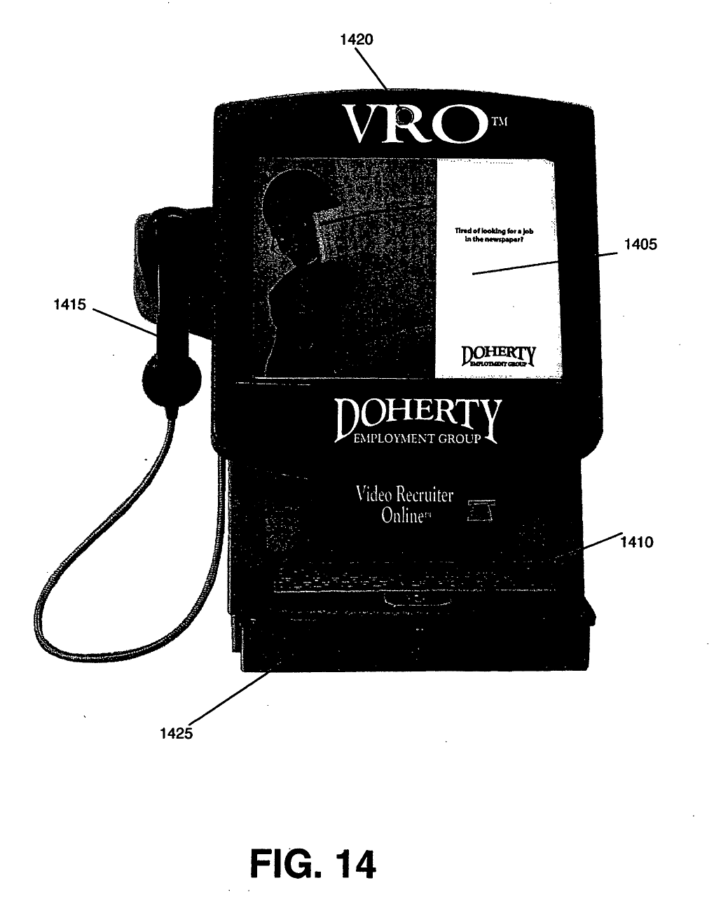

FIG. 14 is an image of a device according to an embodiment of the inventive subject matter described herein. FIG. 14 shows an example of a device such as that contemplated by the schematic illustration of FIG. 2A. The video screen 1405 corresponds to the video output device 216 of FIG. 2A and is capable of displaying a user interface to the candidate making use of the device. The keyboard and trackball 1410 correspond to the data input device 214 as contemplated by FIG. 2A and are capable of receiving data from the candidate. The voice communications device 1415 corresponds to the voice communications device 220 as contemplated by FIG. 2A and is capable of receiving and transmitting audio from and to the candidate. The camera 1420 corresponds to the camera 218 as contemplated by FIG. 2A and is capable of actively capturing images and transmitting the same via some processing system. All of the components as depicted in FIG. 14 are housed in a sturdy housing 1425. In an embodiment, the sturdy housing is some ruggedized enclosure capable of withstanding the daily wear and tear of a system exposed to unknown conditions and use.

Though embodiments of the present invention are directed towards the use of systems for the processing of applicants, it is to be understood that there may be applicability to many industries and organizations, such as customer service organizations with a geographically dispersed staff. In such an example, where employees are directed to provide service to customers and report back on progress, problems being experienced, etc, use of a system that provides interaction with personnel in the organizations headquarters would be useful. A single person or a few persons could utilize this system to queue up the interactions with a large number of customer service personnel. The Candidate Processing System could be used to facilitate this interaction, with remote stations being placed in locations accessible to the personnel and configured to connect to the Candidate Processing System.

Although specific embodiments have been illustrated and described herein, it will be appreciated by those of ordinary skill in the art that any arrangement that is calculated to achieve the same purpose may be substituted for the specific embodiments shown. This application is intended to cover any adaptations or variations of the invention. It is manifestly intended that this invention be limited only by the following claims and equivalents thereof.

1. A method comprising:
operating a candidate interviewing process wherein one or more call center operators are trained to process candidates;
wherein the one or more call center operators are positioned at respective operator stations;
the candidate interviewing process receiving a plurality of requests to establish a video teleconference session, wherein each request is sent from a remote station used by at least one of the candidates;
electronically queuing two or more of the requests in a call queue;
connecting one of the queued video teleconferencing sessions from the candidates to one of the operator stations serviced by the candidate interviewing process which is staffed by one of the operators; and
processing the candidate through the video teleconference session.

2. The method of claim 1, wherein the call center operators are located remote to a server computer system that is used to support the candidate interviewing process.

3. The method of claim 1 further including at least one job candidate supplying requested information on-line in association with the processing and the candidate submitting the requested information electronically.

4. The method of claim 3, wherein the candidate interviewing process includes interviewing, screening, hiring, and testing.

5. A method comprising:
performing a candidate interviewing process wherein one or more call center operators are trained to process candidates;
wherein the one or more call center operators are positioned at respective operator stations;
the candidate interviewing process receiving a plurality of requests to establish a communication session selected from the group of a video teleconference session or an instant messaging session, wherein each request is sent from a remote station used by at least one of the candidates;
electronically queuing two or more of the requests for a communication session in a call queue;
connecting one of the queued communication sessions from the candidates to one of the operator stations serviced by the candidate interviewing process which is staffed by one of the operators; and
processing the candidate through the communication session.

6. The method of claim 5, wherein the call center operators are located remote to at least one server system supporting the candidate interviewing process.

7. The method of claim 5 further including at least one job candidate supplying requested information on-line in association with the processing and the candidate submitting the requested information electronically.

8. The method of claim 7, wherein the candidate interviewing process includes interviewing, screening, hiring, and testing.

9. A method comprising:
operating a candidate interviewing process wherein one or more call center operators are trained to process potential job candidates, and wherein the one or more call center operators are positioned at an operator station wherein each station includes a video display;
receiving a plurality of requests to establish a teleconference session, wherein each request is sent from a remote station used by one of the candidates, wherein the remote station includes a video imaging device;
electronically queuing two or more of the requests in a call queue;
connecting one of the queued teleconferencing session requests from the job candidates to one of the operator stations serviced by the candidate interviewing process which is staffed by one of the operators; and
processing the candidate while displaying at least one image acquired in real-time of the candidate on the display at the operator station, wherein the image is obtained using the imaging device at the remote station at substantially the same time as the session.

10. A method according to claim 9 further including at least one job candidate completing a job application on-line in association with the job interview and the job candidate submitting the job application electronically.

11. The method of claim 9, wherein the method further comprises locating at least one of the remote stations at a job placement center.

12. A method according to claim 11 further wherein the job placement center is sponsored by a government entity.

13. The method of claim 9, wherein the method further comprises locating at least one of the remote stations at a retail location.

14. The method of claim 9, wherein the method further comprises locating at least one of the remote stations at a client location.

15. The method of claim 9, wherein the method further comprises locating at least one of the remote stations at a private location.

16. The method of claim 9, wherein the method further comprises locating at least one of the remote stations at a public location.

17. The method of claim 9, wherein the remote station is virtually located on the candidate's personal computer via an internet-enabled user interface.

18. Apparatus comprising:
a housing;
a processing system mounted in or on the housing and connected to a network;
a voice communications device connected to the processing system;
a video output device mounted in or on the housing, the video output device connected to the processing system;
a camera mounted in or on the housing, the camera connected to the processing system;
one or more data input devices;
the processing system including one or more software components permitting a candidate user to:
initiate a request for a session to a candidate interviewing process serviced by operators trained to process candidates; and
upon acceptance of the request by the candidate interviewing process, conduct an interview with the operator while at least one image of the candidate user is acquired in real-time by the camera and sent to the operator servicing the interview.

19. The apparatus of claim 18, further including one or more data input devices connected to the processing system and wherein the software components further permit the user to enter requested information into the data input devices.

20. A system comprising:
a video teleconference call center configured to support video teleconferencing between operators serviced by the center and potential job applicants at remote locations;
a plurality of video teleconferencing kiosks located remotely from the call center and available to the potential job applicants, the kiosks configured to request a video teleconference session with an operator at the call center and to establish a video teleconference session when the request is fulfilled; and
a call queuing system associated with the video teleconferencing center that receives requests from kiosks for an interview session and queues the calls and assigns the calls to one of the operators that is available to handle a call.

21. A system according to claim 20 further including offering an instant messaging session as an alternative to the video teleconference session.
